(19) United States
(12) Patent Application Publication
(10) Pub. No.: US 2013/0074006 A1
(43) Pub. Date: Mar. 21, 2013

(54) COMMAND INVOCATION DURING LOG-IN USER AUTHENTICATION TO AN OPERATING SYSTEM

(71) Applicants: JACK W. SZETO, DURHAM, NC (US); RAMRATAN VENNAM, DURHAM, NC (US); PATRICK W. WOLF, DURHAM, NC (US)

(72) Inventors: JACK W. SZETO, DURHAM, NC (US); RAMRATAN VENNAM, DURHAM, NC (US); PATRICK W. WOLF, DURHAM, NC (US)

(73) Assignee: INTERNATIONAL BUSINESS MACHINES CORPORATION, ARMONK, NY (US)

(21) Appl. No.: 13/238,270

(22) Filed: Sep. 21, 2011

(51) Int. Cl. G06F 3/048

(52) U.S. Cl. 715/800; 715/781

(57) ABSTRACT

A user log-in to a system. An embodiment can include, during a user log-in to a system to access a view of a user interface to be presented on a display, receiving a user command to be executed prior to presenting the view on the display, wherein the user is not prompted to enter the user command. Responsive to the user command, the view can be configured in accordance with the user command. The view, as configured in accordance with the user command, can be presented on the display.

### BACKGROUND

One or more embodiments disclosed within this specification relate to a user log-in to a system.

An operating system commonly provides an option to lock a view presented by the operating system on a display, which commonly is known as a screen lock. Oftentimes the operating system is configured to lock the view after a certain period of inactivity. In other situations, a user may select to lock the view when the user does not want others who may be in proximity to the display to see the view.

In general, when the view is locked, the user is logged-out of the view and the view is not presented on the display. In place of the view, a separate log-in view may be presented. That said, the process of locking the view need not terminate the current user session in the operating system. In other words, when a screen lock is applied, the user is only logged off of the operating system with respect to accessing the view, but applications open in the user session can remain open. User inputs entered into the operating system while the screen lock is applied generally are not communicated to applications executing in the user session.

During periods of inactivity, a screen saver may be presented in place of the log-in view, or the display can be presented with a blank screen. When the user desires to disable the screen saver or un-blank the screen, for example when the user returns to the operating system, the user can enter a user input (e.g., via a keyboard, a mouse or a touch screen), to disable the screen saver and/or un-blank the screen. In response to the user input, the log-in view typically is presented on the display.

To unlock the previously presented view, the user typically enters a user authentication, such as a user name and password, a finger scan, or the like, to again log-in to the operating system and return to the user session. Responsive to authentication of the user, the previously presented view usually then is presented on the display.

### BRIEF SUMMARY

One or more embodiments disclosed within this specification relate to a user log-in to a system.

An embodiment can include, during a user log-in to a system to access a view of a user interface to be presented on a display, receiving a user command to be executed prior to presenting the view on the display, wherein the user is not prompted to enter the user command. Responsive to the user command, the view can be configured in accordance with the user command. The view, as configured in accordance with the user command, can be presented on the display.

Another embodiment can include a system that includes a display and a processor. The processor can be configured to, during a user log-in to a system to access a view of a user interface to be presented on the display, receive a user command to be executed prior to presenting the view on the display, wherein the user is not prompted to enter the user command. The processor also can be configured to, responsive to the user command, configure the view in accordance with the user command. The processor further can be configured to present the view, as configured in accordance with the user command, on the display.

Another embodiment can include a computer program product. The computer program product can include a computer-readable storage medium having computer-readable program code embodied therewith, the computer-readable program code configured to perform the various operations and/or functions disclosed within this specification.

### BRIEF DESCRIPTION OF THE SEVERAL VIEWS OF THE DRAWINGS

FIG. 1 is a block diagram illustrating a system for in accordance with one embodiment of the present invention.

FIG. 2 is a view presented on a display in accordance with one embodiment of the present invention.

FIG. 3 is a view presented on a display configured in accordance with one embodiment of the present invention.

FIG. 4 is a flow chart illustrating a method in accordance with another embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Several definitions that apply throughout this document will now be presented. The term “view” is defined as graphic representation of a user operating space (e.g., a desktop) provided by an operating system and represented on a display, for example by a graphical user interface. Within a view, one or more windows can be presented. The term “window” is defined as an object that presents data within a view of a graphical user interface, and that can be minimized while keeping active an application with which the window is associated. A window also can be closed, or can be opened when an application is executed. Oftentimes, the area of the view consumed by a window can be adjusted, for example by dragging one or more edges of the window, maximizing the window, or the like. The term “user command” means a command entered by a user into an operating system or application. A user can be a person (i.e., human being).

The present invention relates to a user log-in to a system. Specifically, during a user log-in to the system to access a view of a user interface to be presented on a display, a user command can be received to be executed prior to presenting the view on the display. The user need not be prompted to enter the user input. In response to the user command, the view can be configured in accordance with the user command, and the view can be presented, as configured in accordance with the user command, on the display. In an embodiment in which the view previously was presented, the configuration of the view can minimize or close one or more windows previously presented in the view. In another embodiment, information that would otherwise be presented in the view absent the user command can be excluded from the view in response to the user command being received.

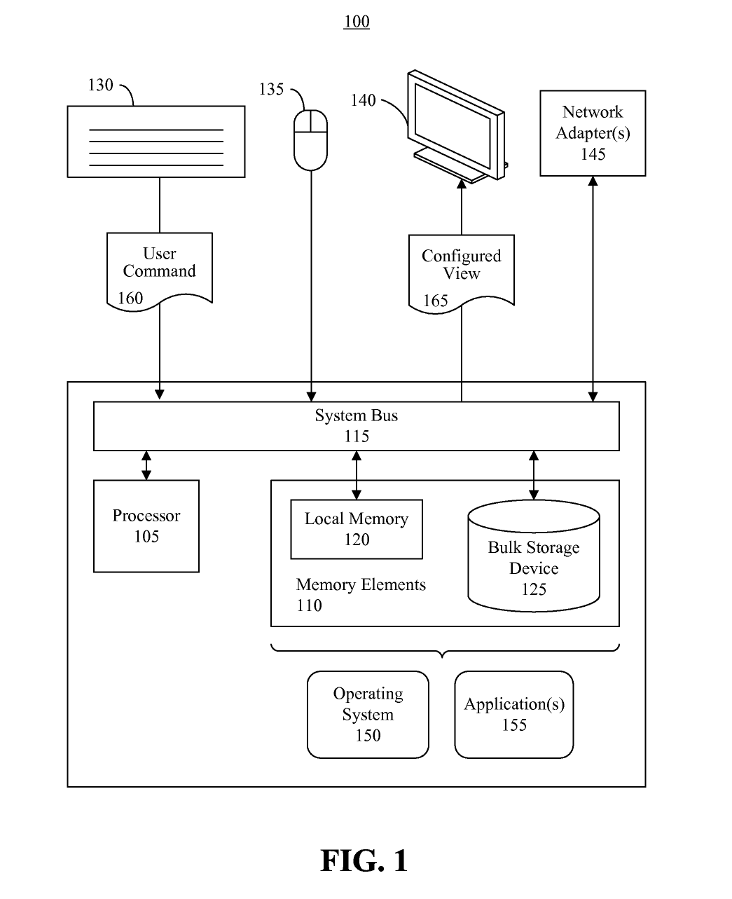

FIG. 1 is a block diagram illustrating a system 100 in accordance with one embodiment of the present invention. The system 100 can include at least one processor 105 coupled to memory elements 110 through a system bus 115. As such, the system 100 can store program code within the memory elements 110. The processor 105 can execute the program code accessed from the memory elements 110 via the system bus 115. In one aspect, for example, the system 100 can be implemented as computer that is suitable for storing and/or executing program code. It should be appreciated, however, that the system 100 can be implemented in the form of any the system comprising a processor and memory that is capable of performing the functions described within this specification.

The memory elements 110 can include one or more physical memory devices such as, for example, local memory 120 and one or more bulk storage devices 125. Local memory 120 refers to random access memory or other non-persistent memory device(s) generally used during actual execution of the program code. The bulk storage device(s) 125 can be implemented as a HDD, SSD, or other persistent data storage device. The system 100 also can include one or more cache memories (not shown) that provide temporary storage of at least some program code in order to reduce the number of times program code must be retrieved from the bulk storage device 125 during execution.

Input/output (I/O) devices such as a keyboard (or keypad) 130 and/or a pointing device (e.g., a mouse) 135 can be coupled to the system 100. A display 140 also can be coupled to the system 100. In one arrangement, in lieu of a keyboard (or keypad) 130, the display 140 can comprise a touch screen configured to receive tactile user inputs. Hereinafter, discussion of receiving a user input includes receiving a user input via the keyboard or keypad 130, the pointing device 135 and/or via the display 140.

The I/O devices can be coupled to the system 100 either directly or through intervening I/O controllers. One or more network adapters 145 also can be coupled to the system 100 to enable the system 100 to become coupled to other systems, computer systems, remote printers, and/or remote storage devices through intervening private or public networks. Modems, cable modems, and Ethernet cards are examples of different types of network adapters 145 that can be used with the system 100.

The I/O devices 130-145 can be communicatively linked to the system 100 via wired communication links and/or wireless communication links. In illustration, one or more of the I/O devices 130-145 can be communicatively linked to the system 100 via one or more communication ports (e.g., serial ports, universal serial bus (USB) ports, IEEE 1394 (FireWire®) ports, serial ATA (SATA) ports, or the like), via a personal area network (PAN) (e.g., Bluetooth®, Zigbee™, etc.), via a communication network, or in any other suitable manner.

In one non-limiting embodiment, one or more systems may be provide communication links between the I/O devices 130-145 and the system bus 115, although the invention is not limited in this regard. In illustration, the system bus 115 can be a system bus of a server, and the I/O devices 130-145 can be communicatively linked to a processing system, such as a computer or terminal, which is linked to the server via a communication network. Accordingly, a user can interact with the computer or terminal, while the server processes information pertaining to the user's interactions. In one example, a computer that is linked to the server can be a workstation or other computing device within a computer network, such as a network domain. In another example, a terminal that is linked to the server can be another type of system, such as an automated teller machine (ATM). Still, the I/O devices 130-145 can be communicatively linked to the system bus 115 in any other suitable manner and the invention is not limited in this regard.

As pictured in FIG. 1, the memory elements 110 can store an operating system 150 and one or more applications 155. Being implemented in the form of executable program code, the operating system 150 and application(s) 155 can be executed by the processor 105 to implement the methods and processes described herein. In this regard, the processor can be configured to perform the methods and processes.

In operation, during a user log-in to the system 100 to access a view of a user interface to be presented on the display 140, a user command 160 can be received by the system 100 prior to presenting the view on the display 140. The user need not be prompted to enter the user input. For example, in the case in which a log-in screen is presented on the display 140, the log-in screen need not include information indicating to the user that the user command 160 may be entered. Accordingly, if another person is in proximity to the display 140, the user may enter the user command 160 without the other person being aware that the command 160 was entered. The user command 160 can be entered via the keyboard (or keypad) 130, via the pointing device 135, or via the display 140 if the display 140 comprises a touch screen.

In response to receiving the user command 160, the operating system 150 can, via the processor 105, execute the command. Responsive to command, the operating system 150 can configure a view in accordance with the user command to generate a configured view 165, and output the configured view 165 to be presented on the display 140. In this regard, the operating system 150 can be configured to execute the user command 160 prior to presenting the view on the display 140. The configured view 165 can be output to the display 140 via the system bus 115 and any intervening I/O controllers, systems, etc.

The user command 160 can indicate to the system 100 not to display within the configured view 165 particular information. Accordingly, the configured view 165 can exclude the particular information from the view presented on the display 140.

In one embodiment, the user command 160 can be received in conjunction with a user log-in to the operating system 150 to un-lock a view of the user interface previously presented on the display 140. In illustration, after a view has been presented by the operating system 150 on the display 140, the view can be locked (e.g., a screen lock can be applied). Thus, the user can be logged-out of the view. The view can be locked, for example, in response to a user input or in response to a period of inactivity. As noted, when a screen lock is applied, the user session can be maintained, and one or more applications 155 executing within the operating system 150 may remain open. Examples of such applications include, but are not limited to, a web browser, a financial application, a word processing application, a spreadsheet application, a graphic design application, an instant messaging client, an electronic mail (email) client, and the like. The applications 155 executed by the system 100, or another system to which the display 140 is communicatively linked, can be presented in the view, prior to the screen lock being applied, in corresponding windows.

When the user desires to unlock the view, the user can log-in to the operating system 150 to cause the view to again be presented on the display 140. If the user desires to have the configured view 165 presented on the display 140 in lieu of the previously presented view, when the user logs-in to the operating system 150, the user can enter the user command 160. The user can enter the command 160 prior to entering the user information required for the log-in, after entering the information required for the log-in, or while entering the information required for the log-in.

In one arrangement, the user can enter the user command 160 by entering any key, or combination of keys, on the keyboard/keypad 130. In an embodiment in which the display 140 comprises a touch screen, the user can enter the user command 160 by entering any key, or combination of keys, on the touch screen. In another arrangement, the user can enter the user command 160 using the pointing device 135, for example by selecting a particular portion of the display 140 with a cursor, or by depressing a button, or a combination of buttons, on the pointing device 135. The user command 160 can indicate to the system 100 not to display within the configured view 165 certain information contained in a view previously presented on the display 140.

In one embodiment, the user command 160 can indicate to the system 100 (e.g., the operating system 150) to minimize or close at least one window previously presented in the view. Accordingly, the configured view 165 can be presented on the display 140 without displaying the content of the windows that are minimized or closed. Thus, if another person is proximate to the display 140, and the user does not want to risk that person viewing information contained in the windows previously presented in the view, entering the user command 160 can ensure that such other person will not view the information. When the command 160 indicates to the operating system 150 to close the windows, the information contained in such windows can be saved and the applications 155 corresponding to the windows can be closed.

In another embodiment, for example when the display 140 is a component of an ATM, the user can select one or more keys on a keypad, or tacitly select a particular portion of the display 140 (in which case the display 140 can be a touch screen), to enter the user command 160. The user command 160 can indicate to the system 100 not to display within the configured view 165 financial information and/or personal information. Accordingly, the configured view 165 can be presented on the display 140 without the financial information and/or personal information. Thus, if another person is proximate to the display 140 of the ATM, and the user does not want to risk that person viewing the financial information and/or personal information, entering the user command 160 can ensure that such other person will not view the information.

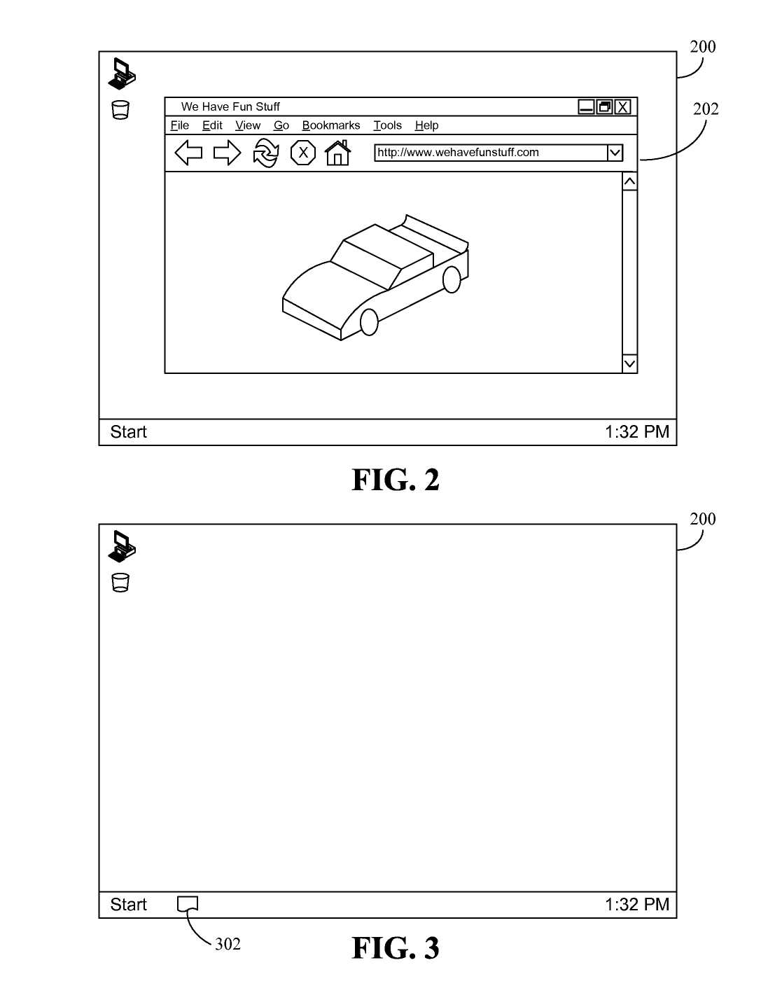

FIG. 2 is a view 200 presented on a display in accordance with one embodiment of the present invention. The view 200 can be presented by the operating system. The view 200 can present at least one window 202. The window 202 can correspond to an application executing on the operating system. For example, the view 202 can correspond to a web browser, or another executable application. The view 200 can be locked, for example as previously described. When the view 200 is locked, a log-in screen can be presented on the display, a blank screen can be presented on the display, one or more graphics and/or text can be presented on the display (e.g., via a screen saver), or the like.

When the user desires to log-in to the operating system to unlock the view 200, the user can enter one or more user inputs to log-in to the operating system to unlock the view 200. If a blank screen or one or more graphics and/or text are presented on the display, the user can enter a user input to activate the log-in screen, via which the user log-in to the operating system. When the user enters the user input(s) to unlock the view 200, the user can enter a user command to indicate to the system to configure the view 200 in accordance with the user command. For example, the user command can indicate to the system (e.g., the operating system) to not present within the view particular information, such as the window 202. As noted, the user need not be prompted via the log-in screen, or in any other manner, to enter the user command. Accordingly, other individuals who may be viewing the display need not be aware that the command prompt is being entered by the user, and thus not appraised to the circumstance that the view 200 is to be configured in accordance with the user command.

In response to the user command, the view 200 can be configured in accordance with the user command. For example, the window 202 can be minimized, and the view can be presented as depicted in FIG. 3. If the user command indicates to minimize the window 202, an icon 302 can be presented in the view 200 depicted in FIG. 3 to indicate that the window 202 has been minimized, though this need not be the case.

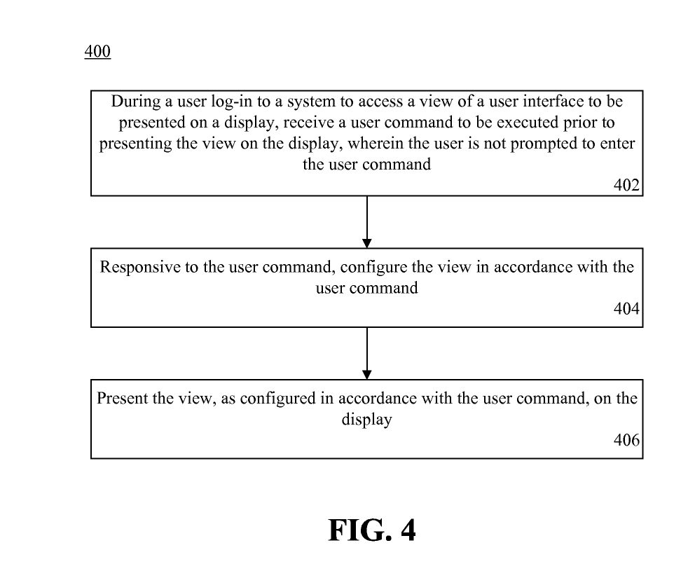

FIG. 4 is a flow chart illustrating a method 400 in accordance with another embodiment of the present invention. At step 402, during a user log-in to a system to access a view of a user interface to be presented on a display, a user command to be executed prior to presenting the view on the display can be received. The user need not be prompted to enter the user command. The user command can be a command indicating to the system not to display within the view particular information. In this regard, the particular information can be excluded from the view presented on the display. The user command can be received in conjunction with a user log-in to the operating system to un-lock the view of the user interface previously presented on the display. In one example, the user command can be a command to minimize at least one window previously presented in the view. In another example, the user command can be a command to close at least one window previously presented in the view.

At step 404, responsive to the user command, the view can be configured in accordance with the user command. In illustration, if the user command indicates to minimize at least one window previously presented in the view, the view can be configured in a manner in which the at least one window can be minimized. If the user command indicates to close at least one window previously presented in the view, the view can be configured in a manner in which the at least one window can be closed.

At step 406, the view, as configured in accordance with the user command, can be presented on the display. In an arrangement in which the at least one window is closed, data presented in the window can be automatically saved in a suitable manner, for example the data can be saved to at least one machine-readable storage device.

In one embodiment, the display can be a display of an ATM. In such embodiment, the user command can be a command indicating to the system to not display within the view financial information. Thus, financial information can be excluded from the view presented on the display. In another example, the user command can be a command indicating to the system to not display within the view personal information. Thus, personal information can be excluded from the view presented on the display. Of course, the user command also can indicate to the system to not display financial information and personal information, in which case both the financial information and personal information can be excluded from the view presented on the display.

Like numbers have been used to refer to the same items throughout this specification. The flowchart and block diagram in the Figures illustrate the architecture, functionality, and operation of possible implementations of systems, methods and computer program products according to various embodiments of the present invention. In this regard, each block in the flowchart or block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method comprising:
during a user log-in to a system to access a view of a user interface to be presented on a display, receiving a user command to be executed prior to presenting the view on the display, wherein the user is not prompted to enter the user command;
responsive to the user command, configuring the view in accordance with the user command; and
presenting the view, as configured in accordance with the user command, on the display.

2. The method of claim 1, wherein:
the user command is a command indicating to the system not to display within the view particular information; and
presenting the view on the display comprises excluding the particular information from the view.

3. A method of claim 1, wherein:
the user command is received in conjunction with a user log-in to the operating system to un-lock the view of the user interface previously presented on the display.

4. The method of claim 3, wherein:
the user command is a command to minimize at least one window previously presented in the view; and
configuring the view comprises minimizing the at least one window within the view.

5. The method of claim 3, wherein:
the user command is a command to close at least one window previously presented in the view; and
configuring the view comprises closing the at least one window within the view.

6. The method of claim 5, further comprising:
when the at least one window is closed, saving data corresponding to the at least one window to at least one machine readable storage device.

7. The method of claim 1, wherein the display is a display of an automated teller machine (ATM).

8. The method of claim 7, wherein:
the user command is a command indicating to the system to not display within the view financial information; and
presenting the view on the display comprises excluding the financial information from the view.

9. The method of claim 7, wherein:
the user command is a command indicating to the system to not display within the view personal information related to the user; and
presenting the view on the display comprises excluding the personal information from the view.

10. A system comprising:
a display; and
a processor configured to:
during a user log-in to a system to access a view of a user interface to be presented on the display, receive a user command to be executed prior to presenting the view on the display, wherein the user is not prompted to enter the user command;
responsive to the user command, configure the view in accordance with the user command; and
present the view, as configured in accordance with the user command, on the display.

11. The system of claim 10, wherein:
the user command is a command indicating to the system not to display within the view particular information; and
the processor is configured to present the view on the display in a manner that excludes the particular information from the view.

12. A system of claim 10, wherein:
the user command is received in conjunction with a user log-in to the operating system to un-lock the view of the user interface previously presented on the display.

13. The system of claim 12, wherein:
the user command is a command to minimize at least one window previously presented in the view; and
the processor is configured to present the view on the display in a manner that minimizes the at least one window within the view.

14. The system of claim 12, wherein:
the user command is a command to close at least one window previously presented in the view; and
the processor is configured to close the at least one window within the view.

15. The system of claim 14, wherein the processor further is configured to:
when the at least one window is closed, save data corresponding to the at least one window to at least one machine readable storage device.

16. The system of claim 10, wherein the display is a display of an automated teller machine (ATM).

17. The system of claim 16, wherein:
the user command is a command indicating to the system to not display within the view financial information; and
the processor is configured to present the view on the display in a manner that excludes the financial information from the view.

18. The system of claim 16, wherein:
the user command is a command indicating to the system to not display within the view personal information related to the user; and
the processor is configured to present the view on the display in a manner that excludes the personal information from the view.

19. A computer program product, the computer program product comprising:
a computer-readable storage medium having computer-readable program code embodied therewith, the computer-readable program code comprising:
computer-readable program code configured to, during a user log-in to a system to access a view of a user interface to be presented on a display, receive a user command to be executed prior to presenting the view on the display, wherein the user is not prompted to enter the user command;
computer-readable program code configured to, responsive to the user command, configure the view in accordance with the user command; and
computer-readable program code configured to present the view, as configured in accordance with the user command, on the display.

20. The computer program product of claim 19, wherein:
the user command is a command indicating to the system not to display within the view particular information; and
the computer-readable program code configured to present the view comprises computer-readable program code configured to exclude the particular information from the view.

21. The computer program product of claim 19, wherein:
the user command is received in conjunction with a user log-in to the operating system to un-lock the view of the user interface previously presented on the display.

22. The computer program product of claim 21, wherein:
the user command is a command to minimize at least one window previously presented in the view; and
the computer-readable program code configured to configure the view comprises the computer-readable program code configured to minimize or close the at least one window within the view.

23. The computer program product of claim 22, further comprising:
computer-readable program code configured to, when the at least one window is closed, save data corresponding to the at least one window when the window is closed to at least one machine readable storage device.

24. The computer program product of claim 19, wherein the display is a display of an automated teller machine (ATM).

25. The computer program product of claim 24, wherein:
the user command is a command indicating to the system to not display within the view financial information or personal information; and
the computer-readable program code configured to present the view on the display comprises computer-readable program code configured to exclude the financial information or the personal information from the view.
